(19) United States
(12) Patent Application Publication
(10) Pub. No.: US 2026/0259033 A1
(43) Pub. Date: Sep. 3, 2026

(54) METHOD AND APPARATUS FOR DIGITALIZED FLESHING SCORE MEASUREMENTS IN PRECISION FARM MANAGEMENT

(71) Applicant: BOARD OF TRUSTEES OF THE UNIVERSITY OF ARKANSAS, Little Rock, AR (US)

(72) Inventors: Dongyi WANG, Farmington, AR (US); Gabriel COX, Fayetteville, AR (US); Casey Owens HANNING, Springdale, AR (US)

(73) Assignee: BOARD OF TRUSTEES OF THE UNIVERSITY OF ARKANSAS, Little Rock, AR (US)

(21) Appl. No.: 19/163,802

(22) PCT Filed: Mar. 11, 2024
(86) PCT No.: PCT/US2024/019427

§ 371 Date: Sep. 9, 2025

Related U.S. Application Data
(60) Provisional application No. 63/489,801, filed on Mar. 13, 2023.

(51) Int. Cl. G01B 7/30; A01K 45/00; G01D 5/16

(52) U.S. Cl. CPC G01B 7/30; A01K 45/00; G01D 5/16

(57) ABSTRACT

An apparatus and method for obtaining a fleshing score measurement from a bird. The measurement apparatus has an angle measurement device with a first rotary arm, connected below the first rotary arm at a pivot joint, and a rotary positioning sensor at the pivot joint. The method for obtaining a fleshing score measurement from a bird includes calibrating a measurement apparatus, positioning the angle measurement device against a bird, obtaining an angle measurement, recording the angle measurement, and correlating the angle measurement with a fleshing score.

### CROSS-REFERENCE TO RELATED APPLICATIONS

This application claims the benefit of U.S. Provisional Patent Application No. 63/489,801 filed on Mar. 13, 2023, and incorporates said provisional application by reference in its entirety into this document as if fully set out at this point.

### BACKGROUND OF THE INVENTION

### 1. Field of the Invention

This invention generally relates to an instrumentality and methodology for precision farm management and, more particularly, a method and apparatus for digitalized fleshing score measurements in precision farm management.

### 2. Description of the Related Art

As farmers seek to optimize their farm management practices, precision farming techniques and technologies have been increasingly implemented to monitor livestock, their products, and the farming environment. Chicken is a widely popular commercial protein and is one of the most feed-efficient and sustainable meats, and as such, the optimization of poultry farming is of particular interest. Farmers must precisely optimize and control for bird body weight and uniformity to achieve peak poultry production and consistency. The measurement of body conformation, or fleshing conformation, relates to the amount of muscle at a bird's breast. Measurement of body conformation (a “fleshing score”) is an important metric for monitoring birds' body uniformity. Fleshing scores can improve feeding strategies and ensure meat and/or egg production efficiency.

FIGS. 1A through 1E illustrate a top view of five (5) birds 100 with different fleshing conditions, providing an index of five (5) fleshing scores. A bird with Score 1 (reference number 102) has poorly developed breast muscle, while a bird with Score 5 (reference number 104) has excess breast muscle. Farmers should avoid Score 1 and Score 5 as unacceptable during the entire production period. On the other hand, the incident rate of Score 2 (reference number 106), Score 3 (reference number 108), and Score 4 (reference number 110) should be carefully controlled at different bird-rearing stages to ensure feeding efficiency and egg production volume. For example, birds with different fleshing scores may be separated into different groups with less competition for feed.

Traditional methods of fleshing score measurement rely heavily on a measuring specialists' subjective judgments. FIG. 2 illustrates a current fleshing score measurement practice, wherein the measuring specialist uses a hand to palpate the lower breast of an individual bird 100 while maintaining a substantially “V-shaped” configuration between two or more of his fingers (e.g., between the thumb and index finger, between the thumb and the other four fingers, etc.). Using the angle between his fingers, the specialist estimates a fleshing score for the bird 100 based on his subjective experience. Such scores are usually recorded by hand on paper. The first fleshing score measurement is generally made at seven days, and the fleshing score can then be monitored and updated weekly. To measure fleshing scores across a poultry production house, no less than fifty (50) representative birds of the flock need to be sampled.

This current practice for taking a fleshing score measurement has several shortcomings. Notably, using an individual measuring specialist's subjective grading judgment does not ensure grading consistency across flocks and poultry production houses. Using specialists to take regular on-site measurements can also be costly, inconvenient, and time-intensive for farmers. Further, because most specialists keep written records of their scores, the resulting grading data is difficult to organize, transfer, visualize, and analyze.

### SUMMARY OF THE INVENTION

Accordingly, it is an object of this invention to provide a new and useful grading apparatus and method that standardize the fleshing score measurement procedure, minimize the evaluation bias caused by subjective measurement techniques, and record digitalized data that can more easily be saved, organized, visualized, and analyzed by farmers for use in optimizing their production.

In general, in a first aspect, the invention relates to an apparatus for digitalized fleshing score measurements for precision poultry farming. The apparatus is configured to quantitatively measure the V-shaped fleshing angle for recording bird body conformation levels. More particularly, the apparatus includes an angle measurement device having a first rotary arm, a second rotary arm connected below the first rotary arm at a pivot joint, and a rotary positioning sensor at the pivot joint. The apparatus also includes a computing device electrically coupled to the angle measurement device.

In one embodiment, each of the first rotary arm and the second rotary arm has a measuring end on a first side of the pivot joint and a handle end at an opposite side of the pivot joint.

In one embodiment, the handle end of the first rotary arm has a first grasping aperture and the handle end of the second rotary arm has a second grasping aperture.

In one embodiment, the angle measurement device further includes a fixed surface positioned between the first rotary arm and the second rotary arm at the pivot joint.

In one embodiment, the rotary positioning sensor is attached to the fixed surface.

In one embodiment, the angle measurement device further includes a track in the first rotary arm and a peg mounted on the fixed surface, wherein the peg is configured to fit within and to slide along the length of the track.

In one embodiment, the rotary positioning sensor is a potentiometer.

In one embodiment, the computing device includes a control board that receives data from the rotary positioning sensor, a data storage that stores the data received from the rotary positioning sensor, a reset button, a save button, and optionally, a visual display.

In one embodiment, the data received from the rotary positioning sensor is an angle measurement corresponding to an angle between the first rotary arm and the second rotary arm.

In general, in a second aspect, the invention relates to a method of obtaining a fleshing score measurement from a bird. The method includes the steps of calibrating a measurement apparatus, positioning an angle measurement device of the measurement apparatus against a bird, obtaining an angle measurement with the rotary positioning sensor, recording the angle measurement on the computing device, and correlating the angle measurement with a fleshing score. The measurement apparatus includes a computing device and the angle measurement device having a first rotary arm, a second rotary arm connected below the first rotary arm at a pivot joint, and a rotary positioning sensor at the pivot joint.

In one embodiment, the calibrating step includes bringing the first rotary arm and the second rotary arm into a closed position and engaging a reset button on the computing device.

In one embodiment, the step of positioning the measurement apparatus against a bird involves suspending the bird upside down.

In one embodiment, the positioning step includes rotating the first rotary arm and the second rotary arm apart from each other, placing the first rotary arm against the bird at a first anterior side position, placing the second rotary arm against the bird at a second anterior side position, and adjusting the first rotary arm and the second rotary arm into a measurement position.

In one embodiment, the positioning step further includes placing the pivot joint against the bird at a central anterior position.

In one embodiment, the obtaining step also includes sensing the angle between the first rotary arm and the second rotary arm to obtain the angle measurement when the first rotary arm and the second rotary arm are in the measurement position and engaging a save button on the computing device to communicate the angle measurement from the rotary positioning sensor to the computing device.

In one embodiment, the recording step includes saving the angle measurement in a digital format on a data storage of the computing device.

In one embodiment, the correlating step further includes building a calibration curve to compare the angle measurement with human-graded fleshing scores.

In one embodiment, the method can also include removing the angle measurement device from the bird and recalibrating the angle measurement device for subsequent use.

In one embodiment, the bird is a chicken, a turkey, a duck, or a goose.

### BRIEF DESCRIPTION OF THE DRAWINGS

The above and other objects and advantages of this invention may be more clearly seen when viewed in conjunction with the accompanying drawing wherein:

FIGS. 1A through 1E are top, anterior cross-section views of five (5) birds providing an index of five (5) fleshing scores.

FIG. 2 illustrates a prior art method of obtaining a fleshing score measurement with an individual bird.

FIG. 3 depicts an example of a fleshing score measurement apparatus with an angle measurement device constructed in accordance with an illustrative embodiment of the invention disclosed herein.

FIG. 4 is a perspective view of the angle measurement device of FIG. 3 shown in use on a live bird.

FIG. 5 is a front elevation view of the angle measurement device of FIG. 3 shown in use on a live bird.

FIG. 6A is a bottom, anterior cross-section view of the angle measurement device of FIG. 3 in use on a live bird.

FIG. 6B is a top, anterior cross-section view of the angle measurement device of FIG. 3 in use on a live bird.

FIG. 7A is an elevation view of an example of an angle measurement device constructed in accordance with an illustrative embodiment of the invention disclosed herein.

FIG. 7B is a partial cutaway view of the angle measurement device shown in FIG. 7A.

FIG. 7C is another partial cutaway view of the angle measurement device shown in FIG. 7A.

FIG. 8 is an anterior cross-section view of the angle measurement device of FIGS. 7A through 7C shown in use.

FIG. 9 is another anterior cross-section views of the angle measurement device of FIGS. 7A through 7C shown in use.

FIG. 10 is a front elevation view of the angle measurement device of FIG. 3 in use on bird carcasses.

FIG. 11 is another front elevation view of the angle measurement device of FIG. 3 in use on bird carcasses.

FIG. 12 11 is another front elevation view of the angle measurement device of FIGS. 7A through 7C in use on a bird carcass.

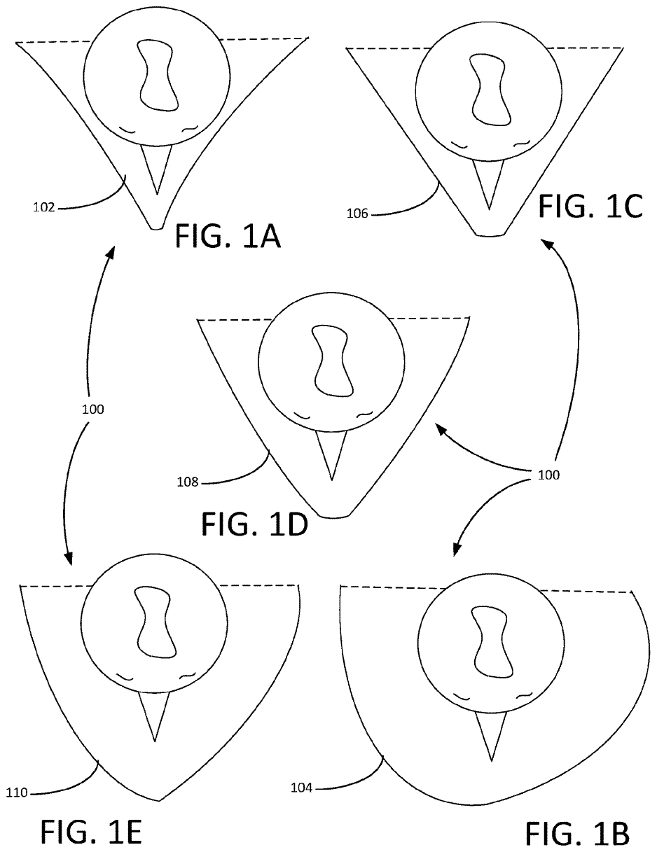

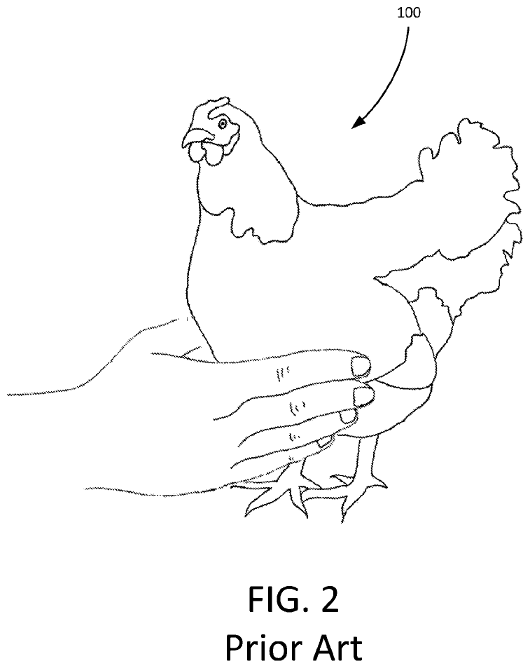

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

The terms “broiler,” “bird,” “poultry”, and “chicken” may be used interchangeably unless distinctions are specifically referenced in this disclosure.

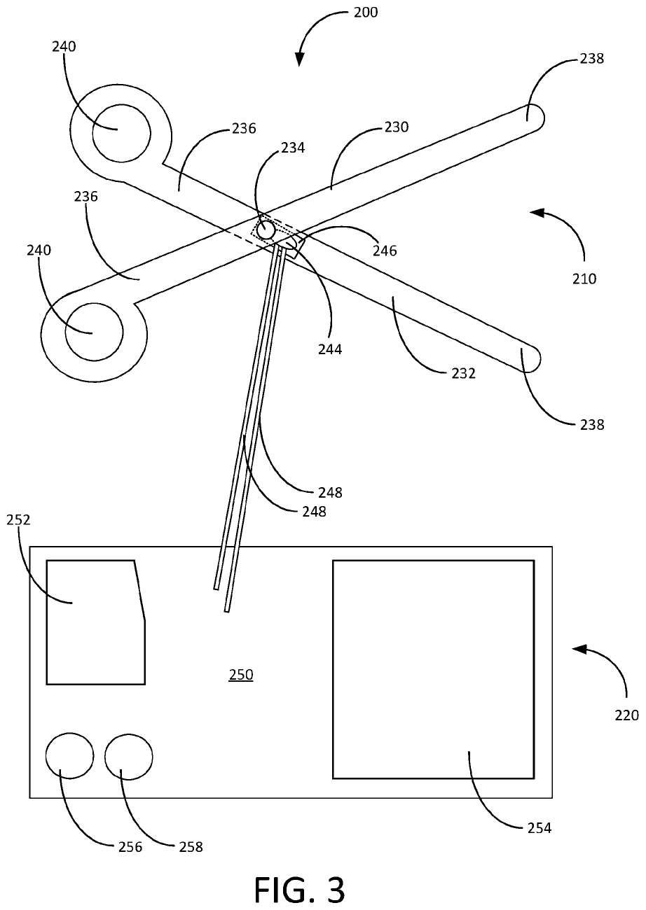

Referring now to the figures of the drawings, wherein like numerals of reference designate like elements throughout the several views, and initially to FIG. 3, a fleshing score measurement apparatus 200 is shown in accordance with an exemplary embodiment. In an embodiment, and as illustrated in the embodiment of FIG. 3, the fleshing score measurement apparatus 200 is configured to be portable. The fleshing score measurement apparatus 200 includes an angle measurement device 210 and a computing device 220.

The angle measurement device 210 includes a first rotary arm 230, a second rotary arm 232, and a pivot joint 234, wherein the first rotary arm 230 is configured above the second rotary arm 232 and connected at the pivot joint 234 to form a V-shaped angle. The rotary arms 230, 232 may be elongated to various lengths with various widths in different suitable embodiments. In the embodiment of FIG. 3, rotary arms 230 has approximately the same length and width as rotary arm 232. Although the rotary arms 230, 232 depicted in FIG. 3 are each generally straight, it will be appreciated that the rotary arms 230, 232 may instead be curved toward or away from each other in other embodiments. The depicted rotary arms 230, 232 have flat upper and lower surfaces, but it will be appreciated that the rotary arms 230, 232 in other embodiments may have a different thickness or shape (e.g., cylindrical). As shown in FIG. 3, each of the rotary arms 230, 232 may be have a handle end 236 on one side of the pivot joint 234 and a measuring end 238 on the other side of the pivot joint 234. The handle end 236 can include finger apertures 240 for use in manipulating the angle measurement device 210. The finger apertures 240 can be configured such that an operator can place a first finger (e.g., a thumb) into the first finger aperture 240 and a second finger (e.g., an index finger) into the second finger aperture 240 to wield the angle measurement device 210 with one hand. In one embodiment where the rotary arms 230, 232 lack finger apertures 240, the rotary arms 230, 232 are biased apart in an open position (e.g., using a spring), and the operator can position the angle measurement device 210 to perform a measurement by pushing rotary arms 230, 232 against the biasing force and toward the closed position. The rotary arms 230, 232 of the angle measurement device 210 may be made of any suitable material, including any material suitable for 3-D printing, such as polycarbonate.

The angle measurement device 210 further includes a rotary positioning sensor 244 mounted between the first rotary arm 230 and the second rotary arm 232 at the pivot joint 234. The rotary positioning sensor 244 in some embodiments is a magnetic Hall-effect rotary positioning sensor wherein the magnetic base is installed on a fixed surface 246 and the magnetic rotary piece is installed on the first rotary arm 230 configured above the fixed surface 246. The rotary positioning sensor 244 can be a potentiometer with a thin configuration. Notwithstanding these examples, it will be appreciated that other appropriate types of rotary positioning sensors may be used with the angle measurement device 210. In the embodiment depicted in FIG. 3, the fixed surface 246 for mounting the rotary positioning sensor 244 is a designated platform that is positioned between the first rotary arm 230 and the second rotary arm 232. It will be appreciated that, in other embodiments, either of the rotary arms 230, 232 may instead serve as the fixed surface 246 for directly mounting the rotary positioning sensor 244.

The rotary positioning sensor 244 is configured to communicate with the computing device 220. As illustrated in FIG. 3, this communication may be accomplished through one of more wires 248 connecting the rotary positioning sensor 244 to the computing device 220. In other embodiments, the rotary positioning sensor 244 communicates with the computing device 220 through wireless transmissions, such as through Wi-Fi, cellular, or Bluetooth. In one non-limiting embodiment, the computing device 220 is mounted directly to the angle measurement device 210.

In various embodiments, the computing device 220 may be a designated computing module, a smartphone, a smartwatch, a tablet, a laptop, or other computer. The computing device 220 includes an embedded computational control board 250 for signal digitalization. The control board 250 may be an Arduino board, a Raspberry Pi board, or any other suitable control board type. The computing device 220 can also include a local data storage 252 in the form of an SD card or micro-SD card, or any other suitable memory. It is appreciated, however, that other types of data storage 252 may be employed by the computing device 220, in addition to or in place of the local data storage 252, including remote storage and cloud-based storage. Either an embedded or remote visual display 254 may be utilized by the computing device 220 to present data, notifications, and/or instructions to an operator or end user. As illustrated in FIG. 3, the visual display 254 may be an LCD screen configured in attachment with the control board 250. In some embodiments, the control board 250 communicates with a separate electronic device, such as a computer system, tablet, or cellphone, and uses the separate electronic device's screen as the visual display 254. The computing device 220 can include two buttons: a reset button 256 and a save button 258. The reset button 256 is used to calibrate the angle measurement device 210 by resetting an angle measurement to zero (the “reset function”). The save button 258 is used to record and save the angle measurement to the data storage 252 (the “save function”). In embodiments where the computing device 220 is a smartphone, a smartwatch, a tablet, a laptop, or other computer, one or more existing buttons on the computing device 220 (e.g., a power button, volume buttons, keyboard keys, etc.) can be used to initiate the reset and save functions. In other embodiments, the reset and save functions are initiated through a touch screen. Where the computing device 220 includes a touch screen, the touch screen may serve as both the visual display 254 and as the instrumentality for initiating the reset and save functions. A compact case (not shown) can be used to cover and protect the control board 250 and the parts attached thereon.

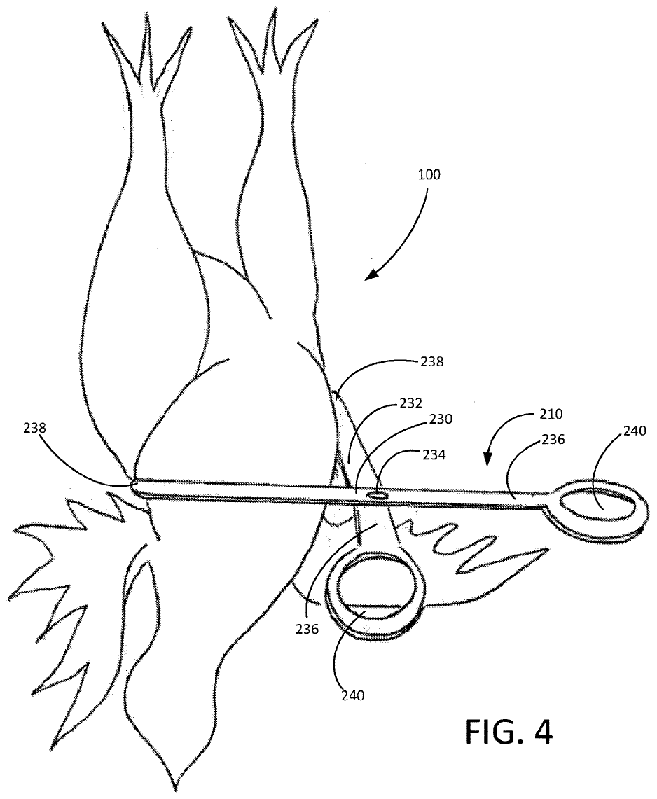

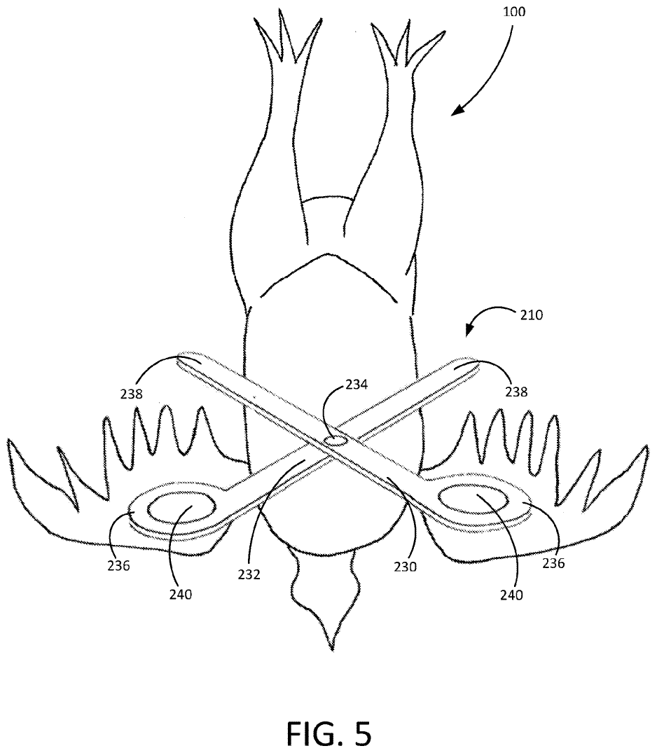

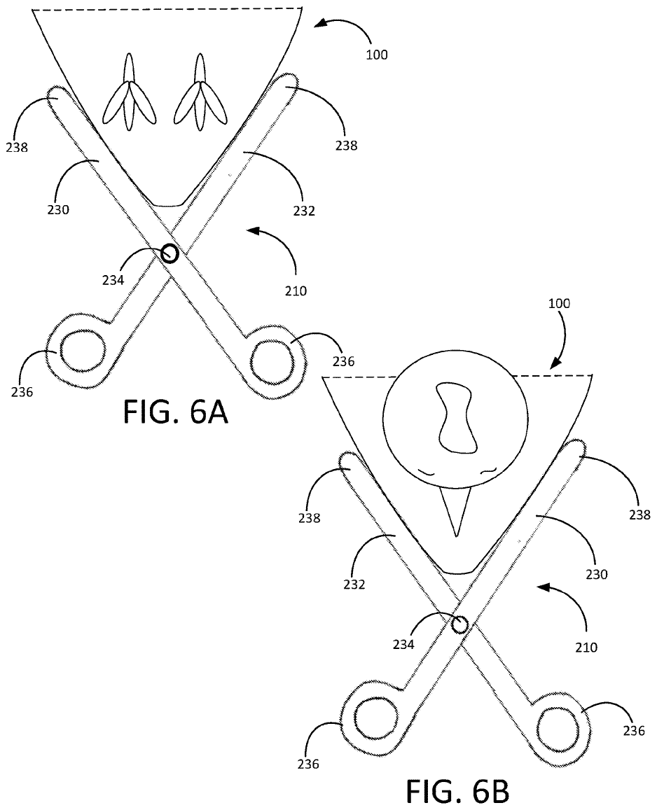

FIGS. 4 and 5 depict an exemplary use of the angle measurement device 210 on a live bird 100, where the angle measurement device 210 is positioned against the front of the bird 100 after it is suspended upside down by its legs. FIGS. 6A and 6B provide additional views for the exemplary use of the angle measurement device 210 on a live bird 100. It will be appreciated that the angle measurement device 210 may be placed against various parts of the bird's anterior (front) anatomy (e.g., at the lower breast, at the keel, etc.) to obtain different desired measurements. For example, for broiler production, the angle measurement device 210 may be used to measure the angle of a breast at keel for an individual bird 100 to identify birds 100 with woody breast condition.

Before an initial measurement, the measuring ends 238 of the angle measurement device 210 are first brought into contact in a closed position. This closed position is maintained while the reset button 256 is engaged or the reset function is otherwise initiated to calibrate the angle measurement device 210 at zero. After calibration, the measuring ends 238 are rotated apart and the angle measurement device 210 is placed at an anterior position on an individual bird 100. In some embodiments, the angle measurement device 210 is calibrated with the reset function before each new angle measurement. Different frequencies for calibration may be suitable in other embodiments. In one embodiment, the computing device 220 prompts the operator to perform a calibration after every ‘X’ measurement, where X denotes 1, 2, 3, 4, 5, 6, 7, 8, 9, 10 or more measurements. In another embodiment, the computing device 220 prompts the operator to calibrate the angle measurement device 210 after the passage of a pre-set period of time (e.g., 10 minutes, 30 minutes, 1 hour).

To perform a measurement, the measuring end 238 of the first rotary arm 230 is maneuvered to one anterior side position on the bird while the measuring end 238 of the second rotary arm 232 is maneuvered to the opposite anterior side position. The angle measurement device 210 is then positioned against the bird 100, such that pivot joint 234 is located proximate to the central anterior position on the bird 100. The rotary arms 230, 232 are adjusted into the measurement position, where both rotary arms 230, 232 rest snugly against the body of the bird 100. This measurement position is maintained while the save button 258 is engaged or the save function is otherwise initiated. The rotary positioning sensor 244 then measures and captures the angle between the measuring ends 238 of the first rotary arm 230 and the second rotary arm 232. This digital angle measurement is communicated to the computing device 220, which saves the measurement in the data storage 252. Once the digital angle measurement is recorded and saved, the angle measurement device 210 may be removed from the bird 100 and used for subsequent measurements.

Each fleshing score may be defined by a pre-set range of angle measurements. For example, angle measurements between 1° to 36° may define Score 1 (reference 102), measurements between 37° to 72° may define Score 2 (reference 106), measurements between 73° to 108° may define Score 3 (reference 108), measurements between 109° to 144° may define Score 4 (reference 110) and measurements between 145° to 180° may define Score 5 (reference 104). It will be appreciated that different ranges of angle measurements may be used to define each fleshing score and that the ranges defining each score need not contain the same number of angle measurements therein, though the ranges of angle measurements used to define different fleshing scores should not overlap. Preferably, a calibration curve is used to compare raw angle measurements and human-graded bird fleshing scores, such that the digitalized angle measurement of the angle measurement device 210 are correlated with human-graded fleshing scores. Data from the fleshing score measurement apparatus 200 may also be migrated to a separate data storage and visualization platform to permit farmers to record and monitor information including fleshing scores, weights, environmental temperature and humidity, feed, and water consumption over long periods of time from one dedicated platform.

After the angle measurement is taken for an individual bird 100, the angle measurement and/or the fleshing score may be displayed in real-time on the visual display 254. In some embodiments, historical angle measurements and/or fleshing scores may also be visualized and analyzed on the visual display 254, either individually or in aggregate. The ability to retrieve historical angle measurements and/or fleshing scores can allow farmers to utilize this data, along with other information, to adjust and optimize management strategies for sustainable and cost-efficient farming management.

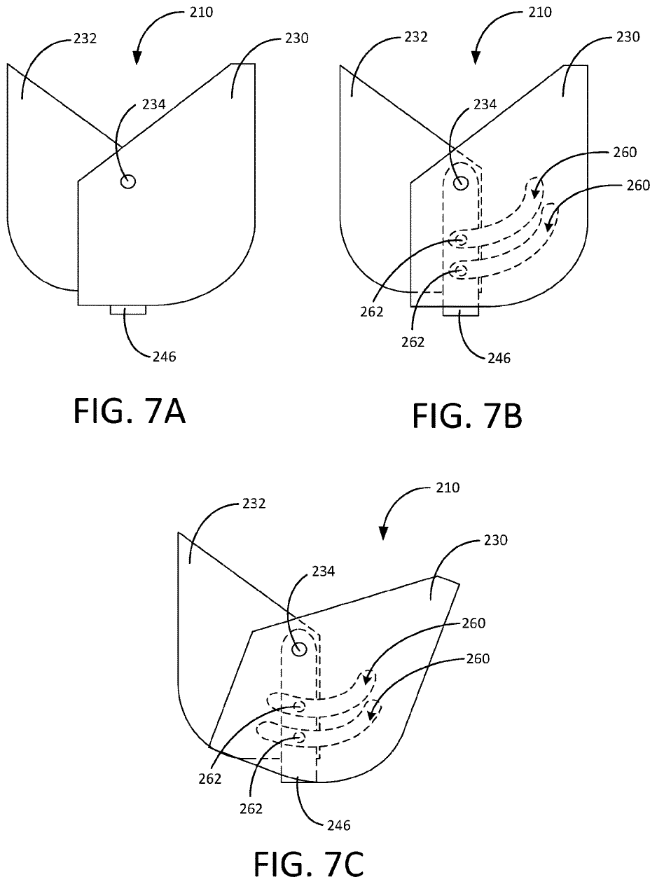

FIGS. 7A through 7C depict the angle measurement device 210 of the fleshing score measurement apparatus 200 in accordance with another exemplary embodiment. As illustrated in FIGS. 7A through 7C, the first rotary arm 230 and the second rotary arm 232 may each be configured to have a combination of angular and rounded sides. The first rotary arm 230 is configured above the second rotary arm 232 and connected at the pivot joint 234, such that the rotary arms 230, 232 form a V-shaped angle. The fixed surface 246 is configured between the first rotary arm 230 and the second rotary arm 232. As shown in the partial cutaway view of FIGS. 7B and 7C, the first rotary arm 230 may include one or more tracks 260 that correspond with one or more pegs 262 mounted to the fixed surface 246. As the first rotary arm 230 is rotated to widen the V-shaped angle between the first rotary arm 230 and the second rotary arm 232, the one or more pegs 262 slide together along the one or more corresponding tracks 260. In the embodiment depicted in FIGS. 7A through 7C, the first rotary arm 230 and the second rotary arm 232 are not brought into contact in a closed position when the pegs 262 are positioned at the innermost end of the tracks 260. In such an embodiment, calibration of the angle measurement device 210 may occur when the arms 230, 232 are positioned for the smallest possible angle measurement (see FIG. 7B), which may be a known angle (e.g., 100°). Although the smallest possible angle measurement for the angle measurement device 210 depicted in FIGS. 7A through 7C is greater than 90°, it will be appreciated that angle measurements less than 90°, including without limitation an angle measurement of 0°, may be obtained using longer tracks 260 disposed on a longer rotary arm 230.

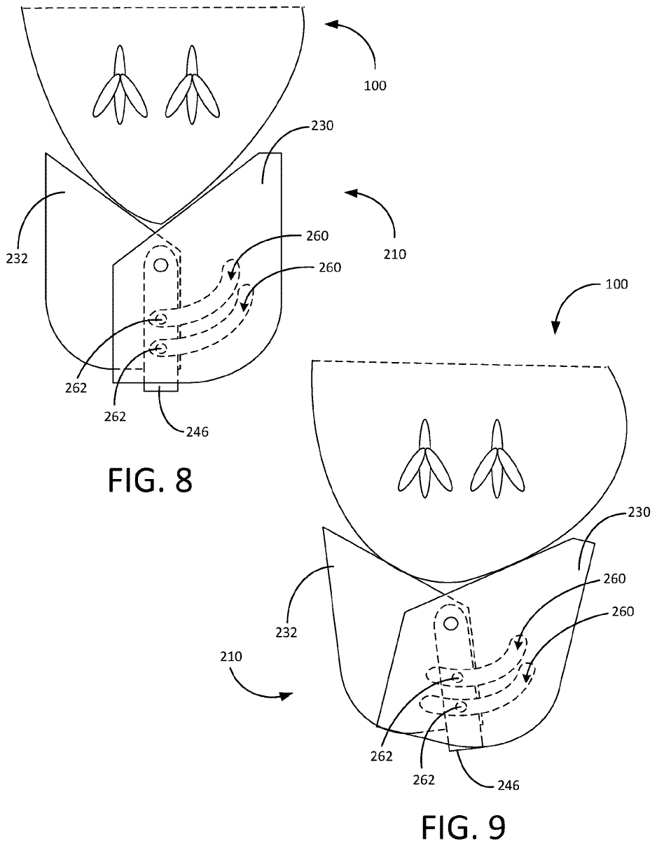

FIGS. 8 and 9 depict an exemplary use of the angle measurement device 210 of FIGS. 7A through 7C on live birds 100. The angle measurement device 210 may also include a first handle (not shown) on the first rotary arm 230 and a second handle (not shown) on the second rotary arm 232 to permit the operator to manipulate the angle measurement device 210 with greater control.

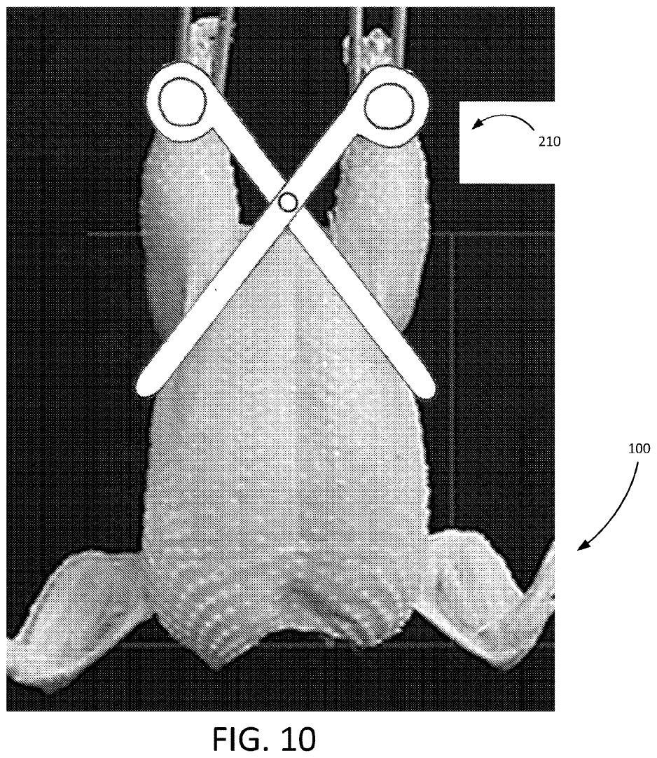

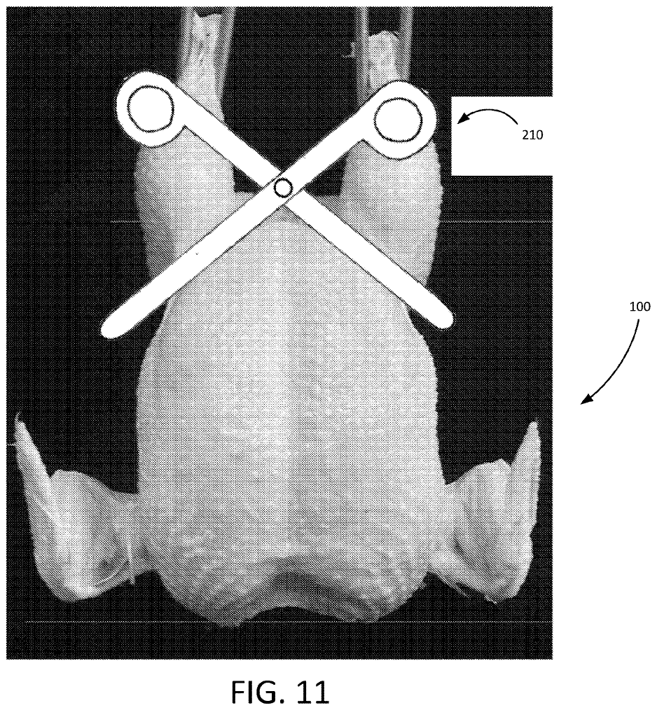

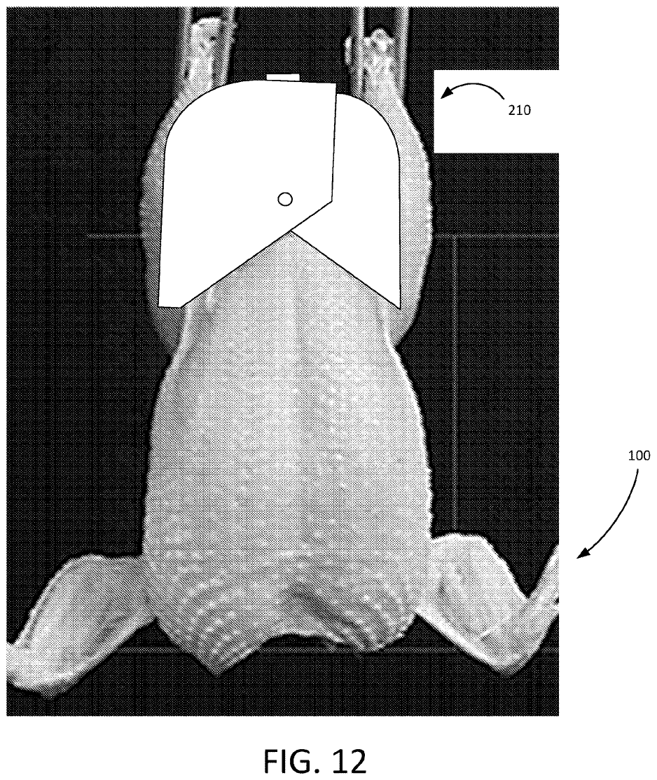

Although the preceding figures demonstrate the use of the angle measurement device 210 with live birds 100, it will be appreciated that the angle measurement device 210 may also be used for grading bird carcasses in a processing line, e.g., in a poultry processing plant. For example, FIGS. 10 and 11 depict the angle measurement device 210 constructed according to an exemplary embodiment in use on, respectively, a normal bird carcass 100 and a bird carcass 100 exhibiting severe woody breast. For this exemplary use, the angle measurement device 210 is used to measure the angle at the keel of the carcass 100. FIG. 12 depicts the use of the angle measurement device 210 with a bird carcass 100, wherein the angle measurement device 210 is constructed according to another exemplary embodiment.

Although in most applications, the angle measurement device 210 is used to measure an inverted bird 100, it will be appreciated that the angle measurement device 210 may be employed against a bird 100 at other orientations, such as a bird 100 in an upright, horizontal, or substantially horizontal position. Further, although the angle measurement device 210 may be used to optimize farm management practices for sustainable chicken growth, and in particular for broiler production, it will be appreciated that the angle measurement device 210 may also be used to measure and grade other fowl, such as turkeys, ducks, and geese.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the process to be operated in a particular orientation. Terms, such as “connected,” “connecting,” “attached,” “attaching,” “join” and “joining” are used interchangeably and refer to one structure or surface being secured to another structure or surface or integrally fabricated in one piece.

As noted above, the apparatus for digitalized fleshing score measurements may be further implemented in connection with a computer system using hardware, software, firmware, tangible computer-readable media having instructions stored thereon, or a combination thereof and may be implemented in one or more computer systems or other processing systems.

If programmable logic is used, such logic may execute on a commercially available processing platform or a special-purpose device. One of ordinary skill in the art may appreciate that embodiments of the disclosed subject matter can be practiced with various computer system configurations, including multi-core multi-processor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the inventions may be implemented in terms of this example computer system. After reading this description, it will become apparent to a person skilled in the relevant art how to implement one or more of the inventions using other computer systems and/or computer architectures. Although operations may be described as a sequential process, some of the operations may be performed in parallel, concurrently, and/or in a distributed environment and with program code stored locally or remotely for access by single or multi-processor machines. In addition, in some embodiments, the order of operations may be rearranged without departing from the spirit of the disclosed subject matter.

The processor device may be a special-purpose or a general-purpose processor device or maybe a cloud service wherein the processor device may reside in the cloud. As will be appreciated by persons skilled in the relevant art, the processor device may also be a single processor in a multi-core/multi-processor system, such system operating alone or in a cluster of computing devices operating in a cluster or server farm. The processor device is connected to a communication infrastructure, for example, a bus, message queue, network, or multi-core message-passing scheme.

The computer system also includes a main memory, for example, random access memory (RAM), and may also include a secondary memory. The secondary memory may include, for example, a hard disk drive or a removable storage drive. The removable storage drive may include a floppy disk drive, a magnetic tape drive, an optical disk drive, a flash memory, a Universal Serial Bus (USB) drive, or the like. The removable storage drive reads from and/or writes to a removable storage unit in a well-known manner. The removable storage unit may include a floppy disk, magnetic tape, optical disk, etc., which is read by and written to by the removable storage drive. As will be appreciated by persons skilled in the relevant art, the removable storage unit includes a computer usable storage medium having stored therein computer software and/or data.

The computer system (optionally) includes a display interface (which can include input and output devices such as keyboards, mice, etc.) that forwards graphics, text, and other data from communication infrastructure (or from a frame buffer not shown) for display on a display unit.

In alternative implementations, the secondary memory may include other similar means for allowing computer programs or other instructions to be loaded into the computer system. Such means may include, for example, the removable storage unit and an interface. Examples of such means may include a program cartridge and cartridge interface (such as that found in video game devices), a removable memory chip (such as an EPROM, PROM, or Flash memory) and associated socket, and other removable storage units and interfaces which allow software and data to be transferred from the removable storage unit to computer system.

The computer system may also include a communication interface. The communication interface allows software and data to be transferred between the computer system and external devices. The communication interface may include a modem, a network interface (such as an Ethernet card), a communication port, a PCMCIA slot, and card, or the like. Software and data transferred via the communication interface may be in the form of signals, which may be electronic, electromagnetic, optical, or other signals capable of being received by the communication interface. These signals may be provided to the communication interface via a communication path. Communication path carries signals, such as over a network in a distributed computing environment, for example, an intranet or the Internet, and may be implemented using wire or cable, fiber optics, a phone line, a cellular phone link, an RF link, or other communication channels.

In this document, the terms “computer program medium” and “computer usable medium” are used to generally refer to media such as removable storage unit, removable storage unit, and a hard disk installed in the hard disk drive. The computer program medium and computer usable medium may also refer to memories, such as main memory and secondary memory, which may be memory semiconductors (e.g., DRAMs, etc.) or cloud computing.

Computer programs (also called computer control logic) are stored in the main memory and/or the secondary memory. The computer programs may also be received via the communication interface. Such computer programs, when executed, enable the computer system to implement the embodiments as discussed herein, including but not limited to machine learning and advanced artificial intelligence. In particular, the computer programs, when executed, enable the processor device to implement the processes of the embodiments discussed here. Accordingly, such computer programs represent controllers of the computer system. Where the embodiments are implemented using software, the software may be stored in a computer program product and loaded into the computer system using the removable storage drive, the interface, the hard disk drive, or the communication interface.

Moreover, embodiments of the disclosure may be practiced with other computer system configurations, including hand-held devices, multi-processor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Embodiments of the inventions also may be directed to computer program products comprising software stored on any computer useable medium. Such software, when executed in one or more data processing devices, causes a data processing device(s) to operate as described herein. Embodiments of the inventions may employ any computer-useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description and with respect to the attached claims.

1. A method of obtaining a fleshing score measurement from a bird, wherein the method comprises the steps of:
calibrating a measurement apparatus, wherein the measurement apparatus comprises:
an angle measurement device comprising:
a first rotary arm;
a second rotary arm connected below the first rotary arm at a pivot joint; and
a rotary positioning sensor at the pivot joint; and
a computing device;
positioning the angle measurement device against a bird;
obtaining an angle measurement with the rotary positioning sensor;
recording the angle measurement on the computing device; and
correlating the angle measurement with a fleshing score.

2. The method of claim 1, wherein the step of calibrating the measurement apparatus further comprises the steps of:
bringing the first rotary arm and the second rotary arm into a closed position; and
engaging a reset button on the computing device.

3. The method of claim 1, wherein the step of positioning the angle measurement device against a bird further comprises the step of suspending the bird upside down.

4. The method of claim 1, wherein the step of positioning the angle measurement device against the bird further comprises the steps of:
rotating the first rotary arm and the second rotary arm apart from each other;
placing the first rotary arm against the bird at a first anterior side position;
placing the second rotary arm against the bird at a second anterior side position; and
adjusting the first rotary arm and the second rotary arm into a measurement position.

5. The method of claim 4, wherein the step of positioning the measurement apparatus against the bird further comprises the step of placing the pivot joint against the bird at a central anterior position.

6. The method of claim 4, wherein the step of obtaining the angle measurement with the rotary positioning sensor further comprises the steps of:
sensing the angle between the first rotary arm and the second rotary arm to obtain the angle measurement when the first rotary arm and the second rotary arm are in the measurement position; and
engaging a save button on the computing device to communicate the angle measurement from the rotary positioning sensor to the computing device.

7. The method of claim 1, wherein the step of recording the angle measurement comprises saving the angle measurement in a digital format on a data storage of the computing device.

8. The method of claim 1, wherein the step of correlating the angle measurement with a fleshing score comprises the step of building a calibration curve to compare the angle measurement with human-graded fleshing scores.

9. The method of claim 1, further comprising the steps of:
removing the angle measurement device from the bird; and
recalibrating the angle measurement device for subsequent use.

10. The method of claim 1, wherein the bird is a chicken, a turkey, a duck, or a goose.

11. An apparatus for digitalized fleshing score measurements, the apparatus comprises:
an angle measurement device, wherein the angle measurement device comprises:
a first rotary arm;
a second rotary arm connected below the first rotary arm at a pivot joint; and
a rotary positioning sensor at the pivot joint; and
a computing device.

12. The apparatus of claim 11, wherein each of the first rotary arm and the second rotary arm comprises a measuring end on a first side of the pivot joint and a handle end at an opposite side of the pivot joint.

13. The apparatus of claim 12, wherein the handle end of the first rotary arm comprises a first grasping aperture and the handle end of the second rotary arm comprises a second grasping aperture.

14. The apparatus of claim 11, wherein the angle measurement device further comprises a fixed surface positioned between the first rotary arm and the second rotary arm at the pivot joint.

15. The apparatus of claim 14, wherein the rotary positioning sensor is attached to the fixed surface.

16. The apparatus of claim 14, wherein the angle measurement device further comprises:
a track in the first rotary arm; and
a peg mounted on the fixed surface, wherein the peg is configured to fit within and to slide along the length of the track.

17. The apparatus of claim 11, wherein the rotary positioning sensor is a potentiometer.

18. The apparatus of claim 11, wherein the computing device comprises:
a control board that receives data from the rotary positioning sensor;
a data storage that stores the data received from the rotary positioning sensor;
a reset button; and
a save button.

19. The apparatus of claim 18, wherein the data received from the rotary positioning sensor is an angle measurement corresponding to an angle between the first rotary arm and the second rotary arm.

20. The apparatus of claim 18, wherein the computing device further comprises a visual display.
